(19) United States
(12) Patent Application Publication
(10) Pub. No.: US 2026/0127131 A1
(43) Pub. Date: May 7, 2026

(54) COMMUNICATION MODULE

(71) Applicant: Murata Manufacturing Co., Ltd., Nagaokakyo-shi (JP)

(72) Inventor: Kazuhiro NAKAMUTA, Nagaokakyo-shi (JP)

(21) Appl. No.: 19/375,711

(22) Filed: Oct. 31, 2025

(30) Foreign Application Priority Data
Nov. 6, 2024 (JP) 2024-194078

(51) Int. Cl. G06F 13/42

(52) U.S. Cl. CPC G06F 13/4282; G06F 2213/0012

(57) ABSTRACT

A communication module includes: an amplification control device connected to a main device to receive, from the main device, a main signal including a command signal, an address signal that identifies an address of at least one register included in an antenna switch and a band select switch, and a write data signal to be recorded in a register corresponding to the address and interpret the command signal; and the antenna switch and the band select switch connected to the amplification control device via a first signal line where a clock signal is transmitted and a second signal line where a data signal is transmitted.

### CROSS REFERENCE TO RELATED APPLICATION

This application claims priority from Japanese Patent Application No. 2024-194078, filed on Nov. 6, 2024. The content of this application is incorporated herein by reference in its entirety.

### BACKGROUND OF THE DISCLOSURE

### 1. Field of the Disclosure

The present disclosure relates to a communication module.

### 2. Description of the Related Art

In a semiconductor device, data transmission and reception may be performed among a plurality of devices via serial communication. In serial communication, the devices include a main device (master device) and sub-devices (slave devices) connected to the main device and, with the main device transmitting a signal to any sub-device, for example, data is written into the sub-device. The sub-device may interpret a command included in the signal from the main device and perform process in response to the command.

A circuit for command interpretation has a large circuit size. Thus, when each sub-device is provided with the circuit for command interpretation, the entire circuit size also increases. Moreover, as a structure in which each sub-device is not provided with the circuit for command interpretation, U.S. Patent Application Publication No. 2017/0192918 describes a structure in which an interface circuit for interpreting a signal from the main device is provided separately from the sub-device.

### BRIEF SUMMARY OF THE DISCLOSURE

In the structure described in U.S. Patent Application Publication No. 2017/0192918, the interface circuit is connected via a clock bus, a data bus, and an enable bus for transmitting an enable signal to a sub-device as a data transmission destination. In the structure described in U.S. Patent Application Publication No. 2017/0192918, the interface circuit selects any sub-device among the plurality of sub-devices via the enable bus to transmit data. In this case, since the enable bus is provided to each sub-device, an area for providing wiring of the enable bus is required, thereby increasing the entire circuit size.

The present disclosure was made in view of these circumstances and has a possible benefit of providing a communication module the circuit size of which can be decreased.

A communication module according to an aspect of the present disclosure includes: a first sub-device connected to a main device; and at least one second sub-device not connected to the main device but connected to the first sub-device via a first signal line where a clock signal is transmitted and a second signal line where a data signal is transmitted.

The first sub-device receives, from the main device, a main signal including a command signal, an address signal that identifies an address of at least one register included in at least one second sub-device, and a write data signal to be recorded in a register corresponding to the address, the address signal being a signal subsequent to the command signal and the write data signal being a signal subsequent to the address signal; interprets the command signal; generates a write instruction signal based on an interpretation result of the command signal after reception of the command signal and during reception of the main signal when information based on the data signal is written in any of the at least one second sub-device; generates the data signal to be supplied based on the interpretation result of the command signal to each of the at least one second sub-device and based on the address signal and the write data signal after reception of the command signal and during reception of the main signal; and supplies the write instruction signal via the first signal line or the second signal line and the data signal via the second signal line to each of the at least one second sub-device after reception of the command signal and during reception of the main signal.

Each of the at least one second sub-device determines whether the register corresponding to the address indicated by the address signal is included in the at least one second sub-device; and writes the write data signal in the register when the register is included in the at least one second sub-device and the write instruction signal is supplied from the first sub-device.

A communication module according to another aspect of the present disclosure includes: a first sub-device connected to a main device to receive, from the main device, a main signal including a command signal and a device ID signal indicating a device ID for identifying a device, interpret the command signal, and have first device ID information allocated thereto; a second sub-device connected to the first sub-device via a first signal line where a clock signal is transmitted and a second signal line where a data signal is transmitted to have second device ID information allocated thereto; and a third sub-device connected to the first sub-device via a third signal line where the clock signal is transmitted and a fourth signal line where the data signal is transmitted to have third device ID information allocated thereto.

In the communication module, the first sub-device determines whether the device ID signal included in the main signal matches the first device ID information the first sub-device has, and determines whether the device ID signal included in the main signal matches the second device ID information or the third device ID information the first sub-device has. When the device ID signal included in the main signal matches the second device ID information the first sub-device has, the first sub-device generates a first sub-device control signal indicating data writing or reading on the second sub-device based on an interpretation result of the command signal, and supplies the first sub-device control signal to the second sub-device. When the device ID signal included in the main signal matches the third device ID information the first sub-device has, the first sub-device generates a second sub-device control signal indicating data writing or reading on the third sub-device based on the interpretation result of the command signal, and supplies the second sub-device control signal to the third sub-device.

According to the present disclosure, it is possible to provide a communication module the circuit size of which can be decreased.

### BRIEF DESCRIPTION OF THE SEVERAL VIEWS OF THE DRAWINGS

FIG. 1 is a diagram depicting one example of a circuit including a communication module according to a first embodiment;

FIG. 2 is a diagram depicting the structure of an amplification control device in the communication module according to the first embodiment;

FIG. 3 is a diagram depicting the structure of a sub-device in the communication module according to the first embodiment;

FIG. 4 depicts one example of a main signal and a data signal according to the first embodiment;

FIG. 5 depicts another example of the main signal and the data signal according to the first embodiment;

FIG. 6 depicts still another example of the main signal and the data signal according to the first embodiment;

FIG. 7 depicts yet another example of the main signal and the data signal according to the first embodiment;

FIG. 8 depicts yet another example of the main signal and the data signal according to the first embodiment;

FIG. 9 is a diagram depicting another example of the structure of the sub-device in the communication module according to the first embodiment;

FIG. 10 is a diagram depicting still another example of the structure of the sub-device in the communication module according to the first embodiment;

FIG. 11 is a diagram depicting one example of a circuit including a communication module according to the first embodiment;

FIG. 12 is a diagram depicting the structure of an amplification control device in the communication module according to the second embodiment;

FIG. 13 is a diagram depicting the structure of a sub-device in the communication module according to the second embodiment;

FIG. 14 depicts one example of signals transmitted and received by the amplification control device and signals transmitted and received by the sub-device according to the second embodiment;

FIG. 15 depicts another example of signals transmitted and received by the amplification control device and signals transmitted and received by the sub-device according to the second embodiment;

FIG. 16 is a diagram depicting one example of a circuit including a communication module according to a third embodiment; and

FIG. 17 is a flowchart depicting process by an amplification control device in the communication module according to the third embodiment.

### DETAILED DESCRIPTION OF THE DISCLOSURE

Embodiments of the present disclosure are described in detail below with reference to the drawings. Note that the same components are provided with the same reference character and redundant description is omitted as much as possible.

### First Embodiment

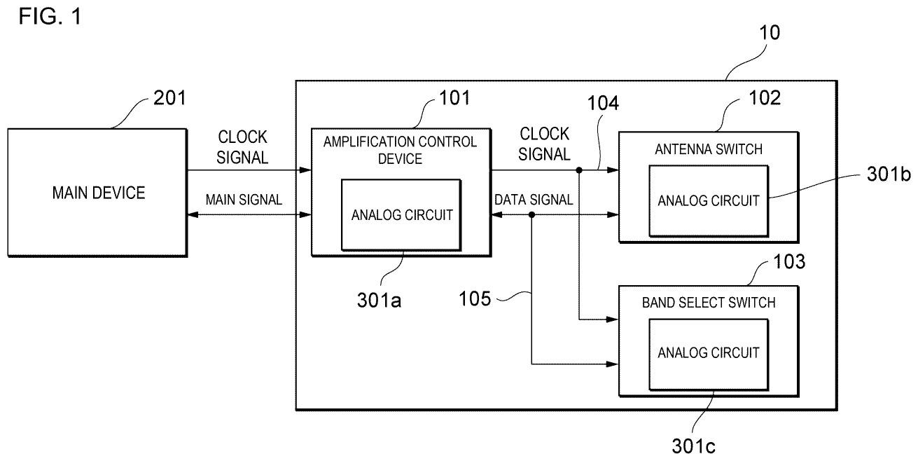

A first embodiment is described. In FIG. 1, an example of a circuit is depicted, including a communication module 10, a main device 201, and analog circuits 301a, 301b, and 301c according to the present embodiment.

The communication module 10 is a sub-device in which its data communication is controlled by the main device 201.

The communication module 10 includes an amplification control device 101, an antenna switch 102, and a band select switch 103. The amplification control device 101 is an amplification control device that controls a power amplifier circuit, the antenna switch 102 is an antenna switch that selects a signal amplified by the power amplifier circuit and transmitted and received via an antenna, and the band select switch 103 is a band select switch that selects the wavelength of a signal transmitted and received via the antenna. Note in the example of FIG. 1 that while the antenna switch 102 and the band select switch 103 are exemplarily depicted as sub-devices, the number of sub-devices may be more than two or may be one. Also, the function of a device connected to the main device 201 is not limited to any of power amplification, antenna control, and wavelength selection, and a device having another function may be connected.

The amplification control device 101 is connected via two wires, a clock signal line 104 and a data signal line 105, to each of the antenna switch 102 and the band select switch 103. With data transmitted and received via a two-wire bus, the amplification control device 101, and the antenna switch 102 and the band select switch 103 perform bidirectional communications. Note that the communication module 10 may follow the I2C scheme or may follow another communication scheme.

The main device 201 transmits a main signal to the amplification control device 101 to rewrite information stored in a register of the antenna switch 102 or the band select switch 103. The main signal includes a command signal, an address signal for specifying the address of at least one register included in the antenna switch 102 or the band select switch 103, and a write data signal to be recorded in the register corresponding to the address. Also, the main device 201 transmits a clock signal to the amplification control device 101.

The command signal has information indicating the type of writing based on the main signal. The command signal has information indicating a writing type, for example, a type of writing in at least one register in a device, a type of writing in one register in a device, or a type of writing in one register in a device while masking a bit value. The address signal has information for identifying each register of the antenna switch 102 or the band select switch 103. The address signal has, for example, data of five bits or eight bits. The write data signal has data to be written in a register and has, for example, eight bits.

The analog circuit 301a is connected to a register of the amplification control device 101 and, based on the information stored in the register of the amplification control device 101, performs control, for example, bias control for power amplification. The analog circuit 301b is connected to a register of the antenna switch 102 and, based on the information stored in the register of the antenna switch 102, performs switching between transmission and reception of a signal via the antenna, for example. The analog circuit 301c is connected to a register of the band select switch 103 and, based on the information stored in the register of the band select switch 103, performs selection of a wavelength of the signal to be transmitted and received via the antenna. While the amplification control device 101 and the antenna switch 102 and the band select switch 103 are described in the present embodiment as different devices, the amplification control device 101, the antenna switch 102 and the band select switch 103 have a common function of controlling the analog circuit based on the information written in their own register.

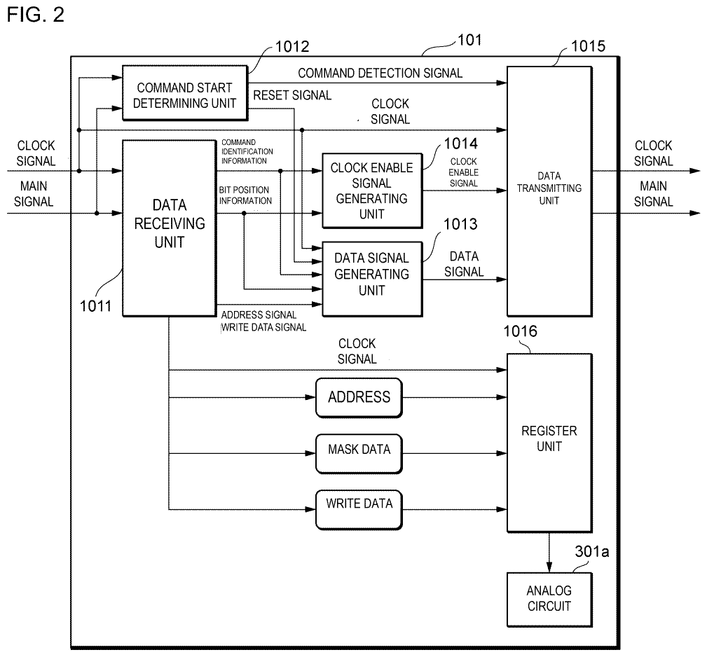

Each unit of the amplification control device 101 is described with reference to FIG. 2. The amplification control device 101 has a data receiving unit 1011, a command start determining unit 1012, a data signal generating unit 1013, a clock enable signal generating unit 1014, a data transmitting unit 1015, and a register unit 1016.

The data receiving unit 1011 performs process of receiving a clock signal and a main signal from the main device 201 and interpreting the main signal. The data receiving unit 1011 generates, for example, based on information indicated by a command signal included in the main signal, command identification information for identifying a command. The data receiving unit 1011 transmits the command identification information to the data signal generating unit 1013 and the clock enable signal generating unit 1014 described further below.

The data receiving unit 1011 transmits an address signal and a write data signal included in the main signal to the data signal generating unit 1013. Also, the data receiving unit 1011 generates bit position information indicating the position where the command identification information is to be added and transmits the bit position information to the data signal generating unit 1013 and the clock enable signal generating unit 1014. Note that the bit position information can include, in addition to the information where the command identification information is to be added, the position of the start and end of a signal in a data signal, such as the start position of the address signal and the start position of the write data signal.

The command start determining unit 1012 determines, based on the clock signal and the main signal, whether transmission of the command signal has started from the main device 201 to the amplification control device 101. Upon the start of supply of the command signal, the command start determining unit 1012 transmits a command detection signal to the data transmitting unit 1015. Also, the command start determining unit 1012 transmits a reset signal to the data signal generating unit 1013.

Based on the command identification information, the bit position information, the address signal, and the write data signal from the data receiving unit 1011, the data signal generating unit 1013 generates a data signal to be transmitted to the antenna switch 102 and the band select switch 103. The data signal generating unit 1013 transmits the data signal to the data transmitting unit 1015.

The clock enable signal generating unit 1014 generates a clock enable signal based on the command identification information and the bit position information. The clock enable signal is a signal for starting transmission of the data signal from the amplification control device 101 to the antenna switch 102. The clock enable signal generating unit 1014 generates a clock enable signal when the timing determined based on the bit position information indicates the time of starting transmission of the data signal to the antenna switch 102 and the band select switch 103, and transmits the clock enable signal to the data transmitting unit 1015.

When receiving an input of the command detection signal and supplied with the clock enable signal from the clock enable signal generating unit 1014, the data transmitting unit 1015 transmits the data signal from the data signal generating unit 1013 together with the clock signal supplied to the data transmitting unit 1015 to the antenna switch 102 and the band select switch 103. The data transmitting unit 1015 transmits the clock signal via the clock signal line 104 and transmits the data signal via the data signal line 105.

The register unit 1016 is a rewritable storage area including registers. Also, the register unit 1016 controls writing to each register based on a signal from the data receiving unit 1011. The register unit 1016 is connected to the analog circuit 301a.

The communication module 10 performs parallel operation of communicating a signal in the communication module 10 concurrently with reception of the main signal. Concurrently with process of interpreting the main signal from the main device 201, the amplification control device 101 performs generation of the data signal to be transmitted to the antenna switch 102 and the band select switch 103 and transmission of the data signal to the antenna switch 102 and the band select switch 103. This enhances process efficiency compared with a case in which, for example, a signal to be written in the antenna switch 102 and the band select switch 103 is stored in the amplification control device 101 and then the information stored in the amplification control device 101 is read and then transmitted to the antenna switch 102 and the band select switch 103.

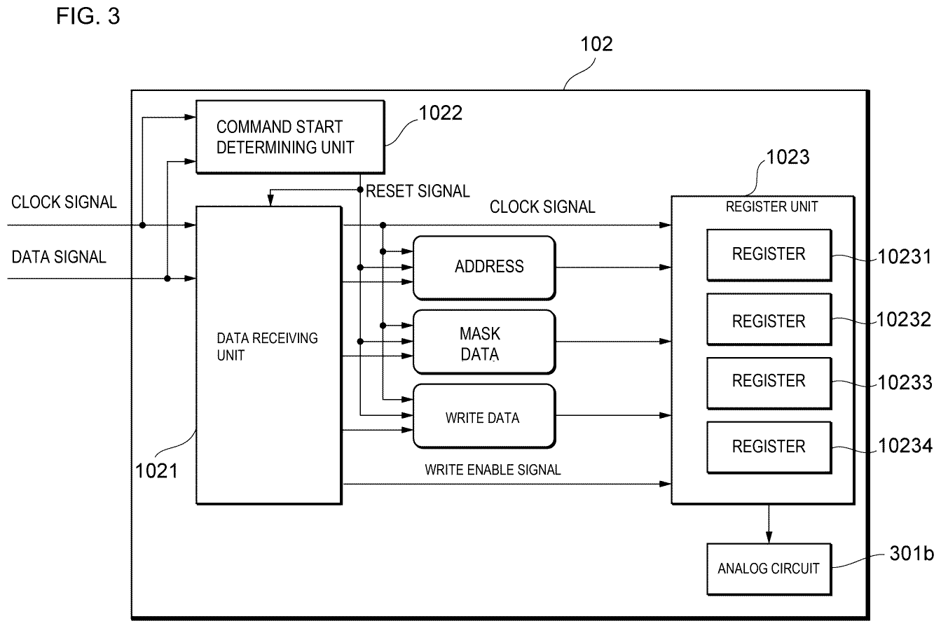

With reference to FIG. 3, the antenna switch 102 is described. Note that other sub-devices including the band select switch 103 also have a similar structure for the data communication device. The antenna switch 102 has a data receiving unit 1021, a command start determining unit 1022, and a register unit 1023.

The data receiving unit 1021 receives the address signal and the write data signal included in the data signal.

The command start determining unit 1022 determines, based on the clock signal and the main signal, whether transmission of the data signal from the amplification control device 101 to the antenna switch 102 has started. Upon the start of supply of the data signal, the command start determining unit 1012 transmits a reset signal to the data receiving unit 1021.

The register unit 1023 is a rewritable storage area including registers 10231, 10232, 10233, and 10234. Also, the register unit 1023 controls writing to each register based on a signal from the data receiving unit 1021. The registers 10231, 10232, 10233, and 10234 each have its unique address. Also, each register of the band select switch 103 has an address different from or identical to the addresses of the registers 10231, 10232, 10233, and 10234. The register unit 1023 is connected to the analog circuit 301b.

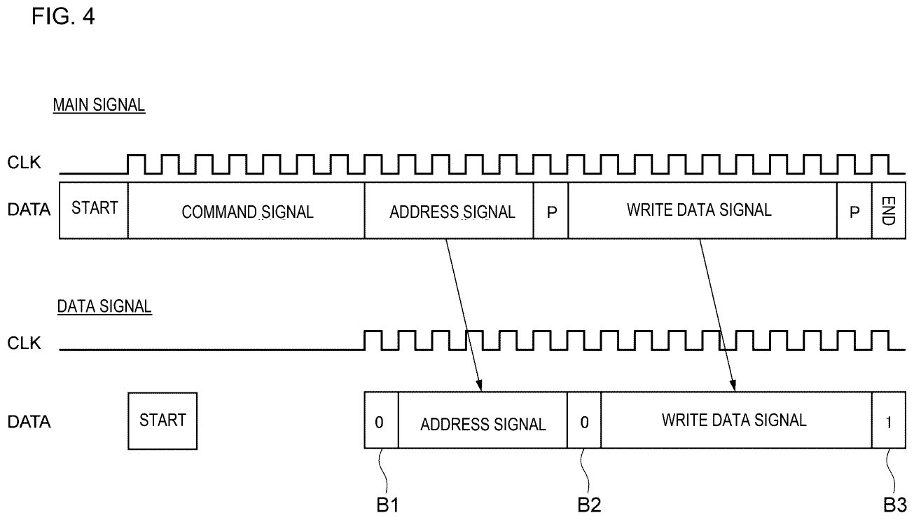

With reference to FIG. 4, one example of generation of a data signal by the amplification control device 101 and interpretation of the data signal by the antenna switch 102 is described. In FIG. 4, an example of the main signal and the data signal is depicted when writing of data to one register is performed with a command for writing to at least one register in a device.

The main signal includes a start signal, a command signal, an address signal, a write data signal, and an end signal in this order.

When the data receiving unit 1011 receives the main signal from the main device 201, the data receiving unit 1011 interprets the command signal. When the command signal is a command indicating writing to at least one register in a device, based on the address signal, the command identification information, and the bit position information, the data signal generating unit 1013 generates information with identification information B1 added to the head of the address signal. The identification information B1 is information of 1 bit, and indicates that the address length is 5 bits when the bit value is 0 and the address length is 8 bits when the bit value is 1. The data transmitting unit 1015 records the identification information B1 at a position corresponding to the head clock of the address signal in the main signal, and transmits the data signal with the address signal shifted by one clock.

Subsequently, the data signal generating unit 1013 generates information with identification information B2 added to the head of the write data signal subsequently to the address signal. The identification information B2 is information of 1 bit, and indicates that the detail of the subsequent signal is a write data signal when the bit value is 0 and the detail of the subsequent signal is a mask signal identifying a bit where writing is not performed when the bit value is 1. The data transmitting unit 1015 takes the data signal corresponding to the head clock of the write data signal in the main signal as the identification information B2, and transmits the data signal with the write data signal shifted by one clock. Also in the data signal, a parity bit is included at each of the head and the tail, and information indicating actual write data is recorded at a bit interposed between the parity bits.

In the example of FIG. 4, one write data signal is included in the main signal. Thus, the data signal generating unit 1013 generates a data signal so that the identification information B3 is added to the parity bit at the tail of the write data signal. The identification information B3 is information of 1 bit, and indicates that writing to a register based on the write data is not performed when the bit value is 0. Here, the register in the antenna switch 102 is not rewritten. Also, when the bit value of the identification information B3 is 1, the identification information B3 indicates that writing to a register based on the write data is performed. The signal with the bit of the identification information B3 being 1 functions as a write instruction signal indicating that the information based on the data signal is written in the register of the sub-device. Note that when the write data signal has an error, for example, the data signal generating unit 1013 does not allow writing by setting the bit value of the identification information B3 at 0.

In the communication module 10, each sub-device such as the antenna switch 102 and the band select switch 103 receives the address signal included in the data signal received by the data receiving unit 1021.

The data receiving unit transmits the write enable signal to the register unit 1023 based on the identification information included in the data signal. The register unit 1023 determines whether the interpreted address information corresponds to the address of the register 10231 or the like included in its own register unit 1023. When the address information corresponds to the address of its own register and the bit value of the identification information B3 is 1, the register unit 1023 writes the write data signal to the corresponding register. Even if the bit value of the identification information B3 is 1, when the interpreted address information does not correspond to the address of any of its own registers, the register unit 1023 does not write to the register 10231 or the like based on the write data signal.

With this, even if the common data signal is transmitted from the amplification control device 101 to a plurality of sub-devices, it is possible to determine whether writing can be finally performed on condition that the address information matches with any address different for each register. Thus, it is possible to appropriately rewrite the register of each sub-device.

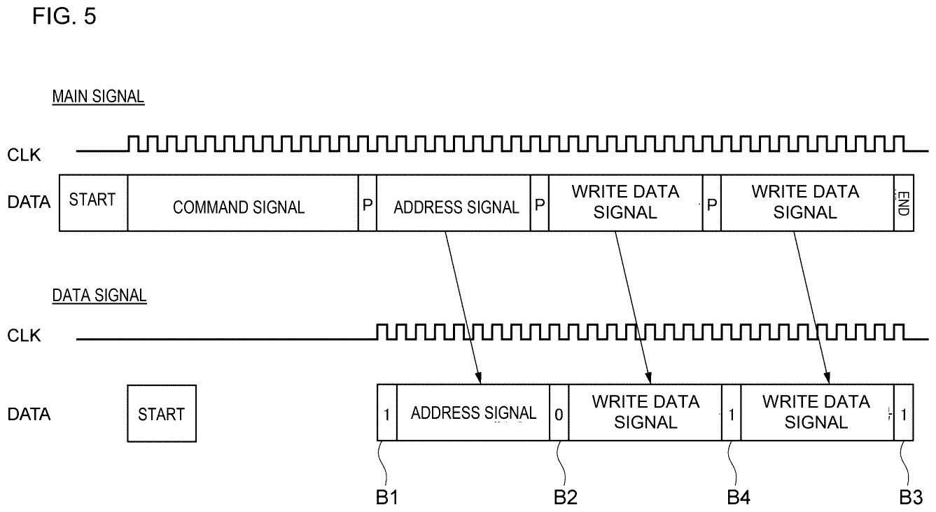

With reference to FIG. 5, another example of generation of a data signal by the amplification control device 101 and interpretation of the data signal by the antenna switch 102 is described. In FIG. 5, an example of the main signal and the data signal is depicted when writing of data to two registers is performed with a command indicating writing to at least one register in a device.

The main signal includes a start signal, a command signal, an address signal, a first write data signal, a second write data signal, and an end signal in this order.

The data transmitting unit 1015 generates information with identification information B1 as 0 added to the head of the address signal. The data signal generating unit 1013 generates information with identification information B2 added to the head of the first write data signal subsequently to the address signal.

Next, the data signal generating unit 1013 generates information with identification information B4 added to the tail of the first write data signal subsequently to the first write data signal. In the example of FIG. 5, the identification information B4 is information of 1 bit, and indicates that, as with the identification information B3, writing to a register based on the write data is not performed when the bit value is 0 and writing to a register based on the write data is performed when the bit value is 1.

Finally, the data signal generating unit 1013 generates a data signal so that the identification information B3 is added to the tail of the write data signal.

Also in the example of FIG. 5, the antenna switch 102 interprets the address information included in the data signal received by the data receiving unit 1021. Here, a case is described by way of example in which the address signal indicates a register of the antenna switch 102 of its own.

The data receiving unit 1021 receives the first write data signal subsequent to the identification information B2 and the address signal. Since the identification information B2 has a bit value of 0, the subsequent data is determined as write data. Subsequently, the data receiving unit 1021 receives the second write data signal subsequent to the identification information B4 and the first data signal. Since the identification information B4 has a bit value of 1, the data receiving unit 1021 determines that the first write data may be written in the register. Finally, the data receiving unit 1021 receives the identification information B3 subsequent to the second write data signal. Since the identification information B3 has a bit value of 1, the data receiving unit 1021 determines that the second write data may be written in the register. Here, the data receiving unit 1021 increments the address indicated by the first address information and writes the second write data in the subsequent register.

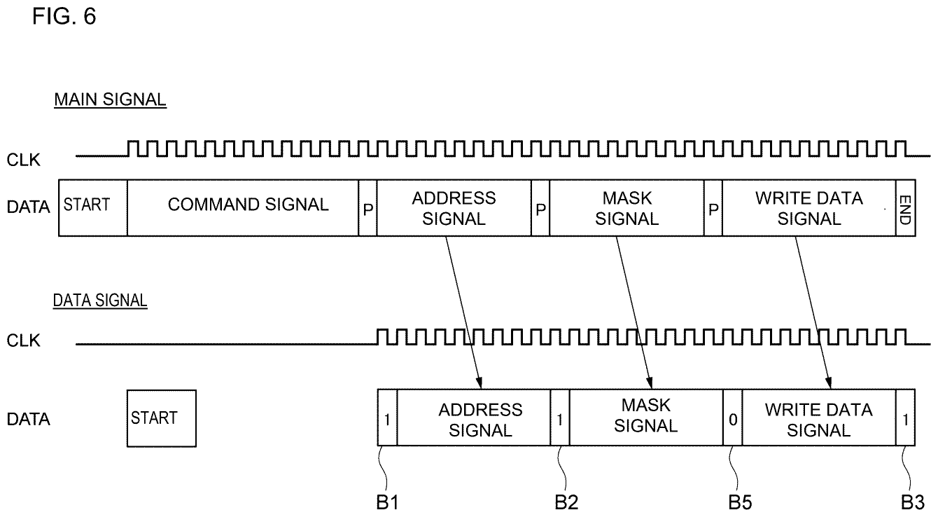

With reference to FIG. 6, still another example of generation of a data signal by the amplification control device 101 and interpretation of the data signal by the antenna switch 102 is described. In FIG. 4, an example of the main signal and the data signal is depicted when writing of data to one register is performed with a command indicating that writing to one register in a device is performed while the bit value is masked.

The main signal includes a start signal, a command signal, an address signal, a mask signal, a write data signal, and an end signal in this order.

The data transmitting unit 1015 generates information with identification information B1 as 0 added to the head of the address signal. The data signal generating unit 1013 generates information with identification information B2 added to the head of the first write data signal subsequently to the address signal. Here, since the command indicates writing to one register in a device as the bit value is masked, the data signal generating unit 1013 sets the bit of the identification information B2 as 1.

Next, the data signal generating unit 1013 generates information with identification information B5 added to the head of the write data signal subsequently to the mask signal. In the example of FIG. 5, the identification information B5 is information of 1 bit, and indicates that, as with the identification information B2, the detail of the subsequent signal is a write data signal when the bit value is 0 and the detail of the subsequent signal is a mask signal indicating a bit to be masked when the bit value is 1.

Finally, the data signal generating unit 1013 generates a data signal so that the identification information B3 is added to the tail of the write data signal.

Also in the example of FIG. 6, the antenna switch 102 interprets the address information included in the data signal received by the data receiving unit 1021.

The data receiving unit 1021 receives the mask signal subsequent to the identification information B2 and the address signal. Since the identification information B2 has a bit value of 1, the subsequent signal is determined as a mask signal.

Subsequently, the data receiving unit 1021 receives the write data signal subsequent to the identification information B5 and the mask signal. Since the identification information B5 has a bit value of 0, the data receiving unit 1021 determines that the detail of the signal is write data. Finally, the data receiving unit 1021 receives the identification information B3 subsequent to the write data signal. Since the identification information B3 has a bit value of 1, the data receiving unit 1021 determines that the write data may be written in the register. Here, the data receiving unit 1021 writes the write data in the register corresponding to the address indicated by the first address information without rewriting the bit indicated by the mask signal.

In the examples from FIG. 4 to FIG. 6, with the data signal generating unit 1013 adding the identification information B3 to the tail of the data signal, the antenna switch 102 can determine whether writing can be performed. However, the data signal generating unit 1013 is not necessarily required to make the identification information B3 included in the data signal. The communication module 10 may let the antenna switch 102 determine whether writing can be performed based on, for example, the presence or absence of a clock signal transmitted from the data transmitting unit 1015.

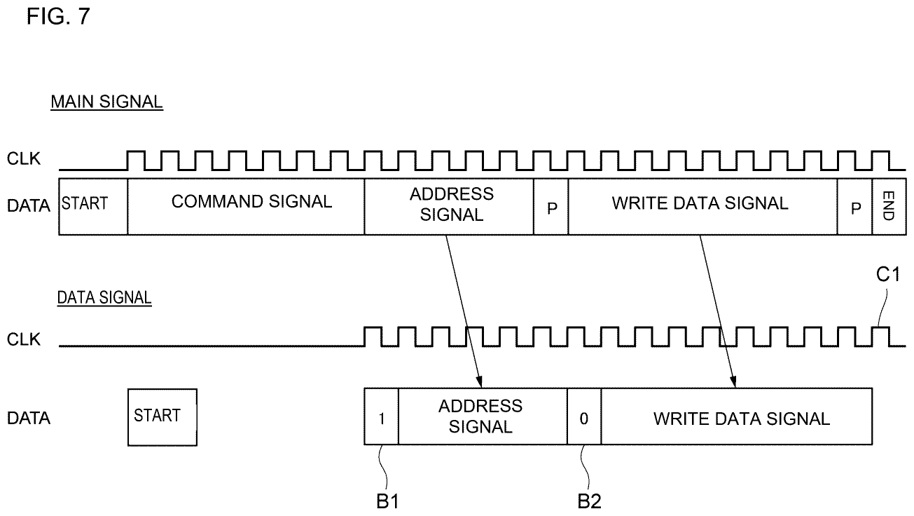

An example of this case is depicted in FIG. 7. In the example of FIG. 7, the main signal is the same as that of FIG. 4. However, a difference from the example of FIG. 4 is that the data signal generating unit 1013 does not add the identification information B3 to the tail of the data signal.

In the example of FIG. 7, when the amplification control device 101 permits the antenna switch 102 to write data, the data transmitting unit 1015 transmits a clock signal C1 to the antenna switch 102 subsequently to the write data signal. When the data receiving unit 1011 receives the clock signal Cl subsequently to the write data signal, the antenna switch 102 determines that data writing can be performed. The clock signal C1 functions as a write instruction signal indicating writing of information based on the data signal to a register of a sub-device.

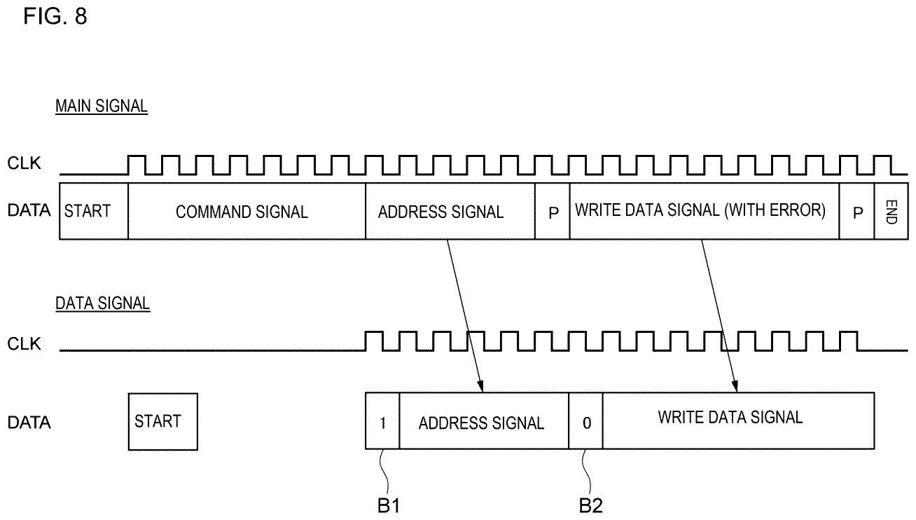

In an example of FIG. 8, the example is depicted in which data writing is not performed due to a reason such as an error in the write data signal. In this case, the data transmitting unit 1015 does not transmit the clock signal to the antenna switch 102 subsequently to the write data signal. Since the data receiving unit 1011 does not receive the clock signal subsequently to the write data signal, the antenna switch 102 does not write data.

In this manner, in the communication module 10, based on the clock signal or the identification information from the amplification control device 101, it is determined whether data writing in the antenna switch 102 or the like can be performed.

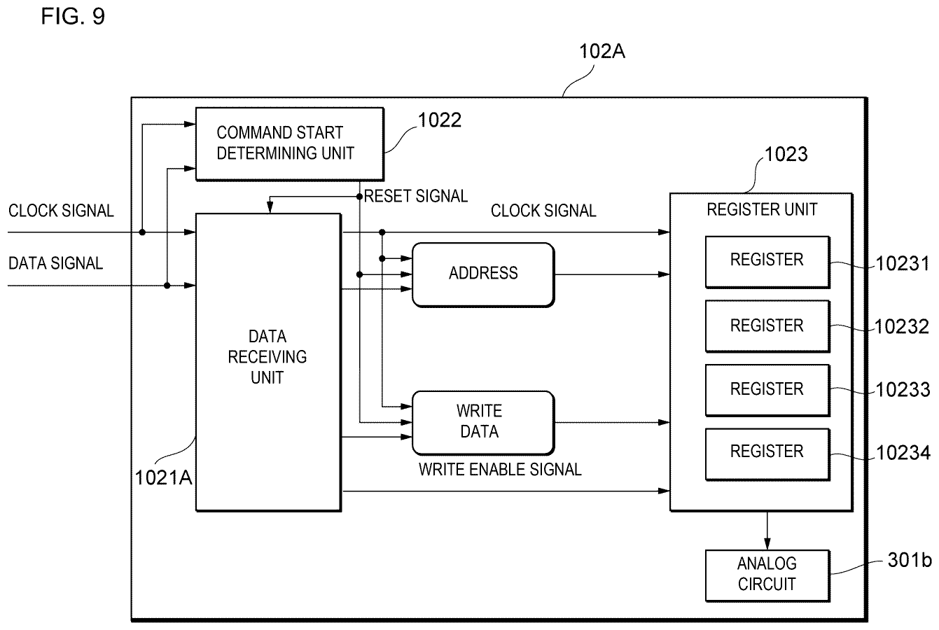

In FIG. 9, an example of another structure of the antenna switch 102 is depicted. An antenna switch 102A having a data receiving unit 1021A can also be set not to perform the process corresponding to a command indicating writing is performed while masking a bit value.

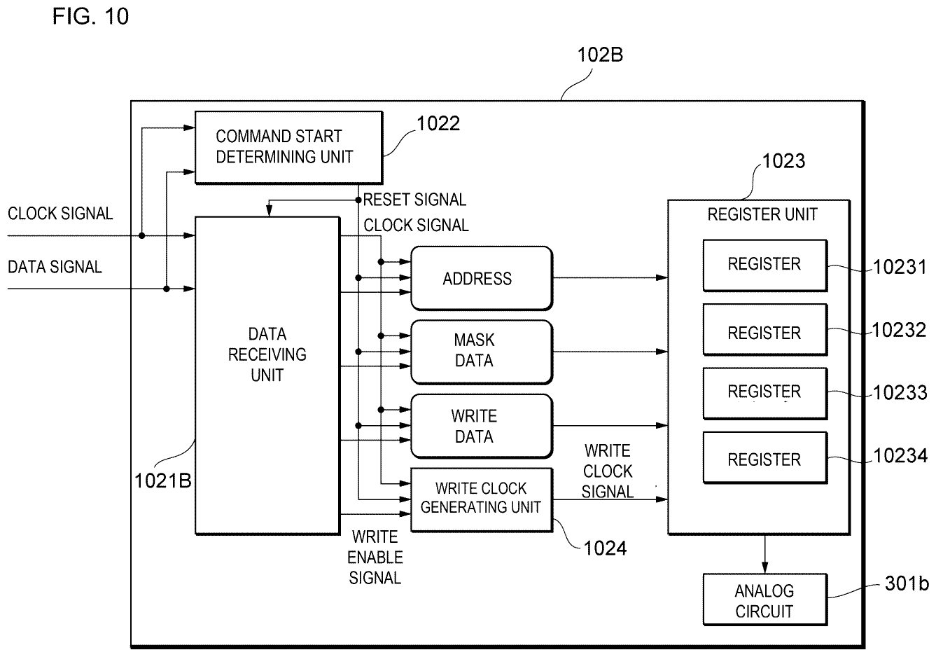

In FIG. 10, an example of still another structure of the antenna switch 102 is depicted. An antenna switch 102B having a data receiving unit 1021B further includes a write clock generating unit 1024, and may convert a write enable signal based on a data signal by the write clock generating unit 1024 and, as described in FIG. 7 and FIG. 8, may control writing to the register unit 1023 based on a clock signal.

### Second Embodiment

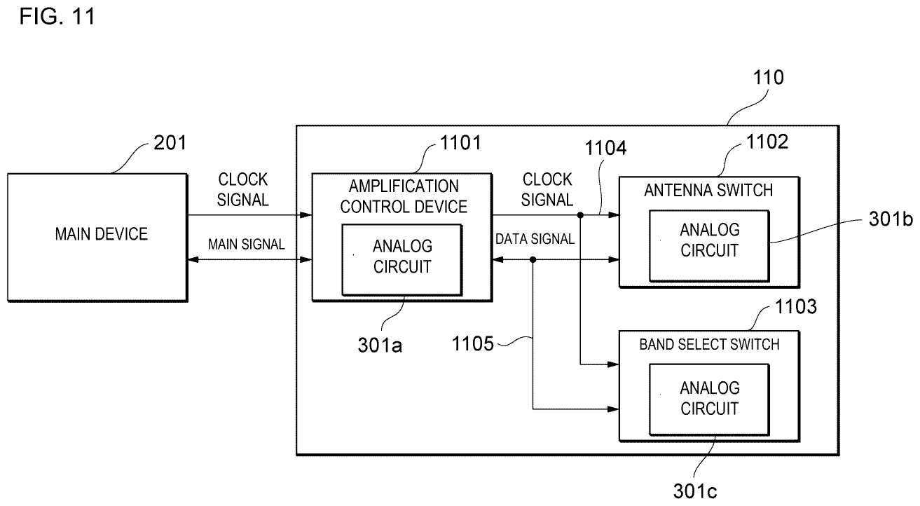

A second embodiment is described. In the second and subsequent embodiments, matters different from those in the first embodiment are mainly described and matters common to the first embodiment are not described. In FIG. 11, one example of a circuit is depicted, including a communication module 110, the main device 201, and the analog circuits 301a, 301b, and 301c according to the second embodiment. The communication module 110 according to the second embodiment is different from the communication module 10 according to the first embodiment in that reading can be performed from a register of an amplification control device 1101A or an antenna switch 1102 or a band select switch 1103.

The communication module 110 is a sub-device in which its data communication is controlled by the main device 201.

The communication module 110 includes an amplification control device 1101, the antenna switch 1102, and the band select switch 1103. As an example, the amplification control device 1101 is an amplification control device that controls a power amplifier circuit, the antenna switch 1102 is a switch that selects a signal amplified by the power amplifier circuit and transmitted and received via an antenna, and the band select switch 1103 is a switch that selects the wavelength of a signal transmitted and received via the antenna. Note in the example of FIG. 11 that while two sub-devices are exemplarily depicted as sub-devices, the number of sub-devices may be more than two or may be one. The amplification control device 1101 has the analog circuit 301a, and the antenna switch 1102 and the band select switch 1103 have the analog circuits 301b and 301c, respectively. The function of each of the analog circuits 301a, 301b, and 301c is similar to that of each analog circuit described in the first embodiment.

The amplification control device 1101 is connected via two wires, a clock signal line 1104 and a data signal line 1105, to each of the antenna switch 1102 and the band select switch 1103. As with the first embodiment, the amplification control device 1101, and the antenna switch 1102 and the band select switch 1103 perform bidirectional communications.

The amplification control device 1101 has a write mode of writing information to a register of its own or writing information to a register of the antenna switch 1102 or the band select switch 1103 and a read mode of reading information from a register of the amplification control device 1101 or a register of the antenna switch 1102 or the band select switch 1103. The antenna switch 1102 and the band select switch 1103 each have a write mode in which information is written in its own register and a read mode in which information is read from its own register. The write mode or the read mode of the amplification control device 1101, the antenna switch 1102, and the band select switch 1103 can be switched based on a signal from the main device 201.

The main device 201 transmits a main signal including a command signal for instruction for writing to the amplification control device 1101 to rewrite information stored in a register of the antenna switch 1102 or the band select switch 1103. Alternatively, the main device 201 transmits a main signal including a command signal for instruction for reading to the amplification control device 1101 to read information stored in a register of the antenna switch 1102 or the band select switch 1103.

The main signal includes a command signal and an address signal identifying the address of at least one register included in the antenna switch 1102 and the band select switch 1103.

The command signal includes information for instruction of writing to a register of the antenna switch 1102 or the band select switch 1103 or information for instruction of reading information stored in a register of the antenna switch 1102 or the band select switch 1103. When the command signal includes information for instruction of writing to a register of the antenna switch 1102 or the band select switch 1103, the command signal includes information indicating a type of writing based on the main signal. The command signal when writing is performed is information indicating a writing format, as with the first embodiment, for example, a format of writing to at least one register in a device, a format of writing to one register in a device, or a format of writing to one register in a device while the bit value is masked.

When writing operation is performed, the main device 201 transmits a main signal including: a command signal including information for instruction of writing to a register of the antenna switch 1102 or the band select switch 1103; an address signal; and a write data signal to be recorded in the register, to the amplification control device 1101.

When reading operation is performed, the main device 201 transmits a main signal including: a command signal including information for instruction of reading information stored in a register of the antenna switch 1102 or the band select switch 1103; and an address signal, to the amplification control device 1101. Also, the main device 201 transmits a clock signal to the amplification control device 1101.

Note that the main device 201 may perform writing to a register of the amplification control device 1101 and reading from a register thereof, and may transmit a main signal indicating writing or reading on the amplification control device 1101 to the amplification control device 1101.

The address signal has information for identifying each register of the antenna switch 1102 or the band select switch 1103. The address signal has, for example, data of five bits or eight bits.

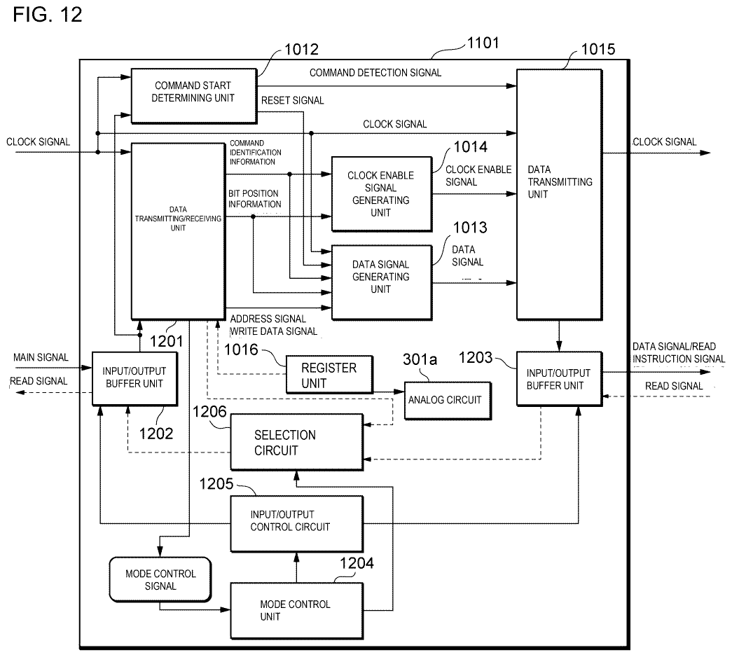

Each unit of the amplification control device 1101 is described with reference to FIG. 12. The amplification control device 1101 has, in addition to each unit of the command start determining unit 1012, the data signal generating unit 1013, the clock enable signal generating unit 1014, and the register unit 1016, which are described in the first embodiment, a data transmitting/receiving unit 1201, input/output buffer units 1202 and 1203, a mode control unit 1204, an input/output control circuit 1205, and a selection circuit 1206. In FIG. 12, a transmission path of a signal corresponding to information read from the amplification control device 1101, the antenna switch 1102, or the band select switch 1103 is indicated by the broken lines.

The data transmitting/receiving unit 1201 performs process of receiving a clock signal and a main signal from the main device 201 and interpreting the main signal. The data transmitting/receiving unit 1201 generates, for example, based on information indicated by a command signal included in the main signal, command identification information for identifying a command. The data transmitting/receiving unit 1201 transmits the command identification information to the data signal generating unit 1013 and the clock enable signal generating unit 1014. Also, the data transmitting/receiving unit 1201 performs control of receiving information read from the antenna switch 1102 or the band select switch 1103 as a read signal from the antenna switch 1102 or the band select switch 1103 and transmitting the read signal to the main device 201. Note that the read signal may be transmitted to the main device 201 as a signal of read information stored in the register unit 1016 of the amplification control device 1101.

The input/output buffer unit 1202 is a circuit that lets a signal in communication between the amplification control device 1101 and the main device 201 pass therethrough. The input/output buffer unit 1203 is a circuit that lets a signal in communication between the amplification control device 1101, and the antenna switch 1102 and the band select switch 1103 pass therethrough.

The mode control unit 1204 is a circuit that controls a write mode or a read mode of the amplification control device 1101. The main device 201 transmits, to the amplification control device 1101, a signal for controlling the write mode or the read mode of the amplification control device 1101. Based on an input from the main device 201, the data transmitting/receiving unit 1201 transmits a mode control signal that sets the write mode or the read mode of the amplification control device 1101 to the mode control unit 1204. Also, in read mode, the mode control signal includes information for setting reading of information from the antenna switch 1102 or the band select switch 1103 or reading of information stored in the amplification control device 1101 of its own.

The mode control unit 1204 has information in accordance with the mode control signal stored therein. The information stored in the mode control unit 1204 is referred to by the input/output control circuit 1205 and the selection circuit 1206.

The input/output control circuit 1205 refers to the information stored in the mode control unit 1204 to determine whether the amplification control device 1101 is in write mode or read mode. The input/output control circuit 1205 transmits a signal for controlling signal transmission and reception by the input/output buffer unit 1202, 1203 to the input/output buffer unit 1202, 1203 in accordance with the setting of the write mode and the read mode.

In write mode, the input/output control circuit 1205 controls the input/output buffer unit 1202 so that the input/output buffer unit 1202 transmits a write data signal included in the main signal to the data transmitting/receiving unit 1201. Also, in write mode, the input/output control circuit 1205 controls the input/output buffer unit 1203 so that the input/output buffer unit 1203 transmits a data signal or a read instruction signal to the antenna switch 1102 and the band select switch 1103.

On the other hand, in read mode, the input/output control circuit 1205 controls the input/output buffer unit 1202 so that the input/output buffer unit 1202 transmits a read signal from the antenna switch 1102, the band select switch 1103, or the amplification control device 1101 via the amplification control device 101 to the main device 201. Also, in read mode, the input/output control circuit 1205 controls the input/output buffer unit 1203 so that the input/output buffer unit 1203 transmits a read signal from the antenna switch 1102 or the band select switch 1103 to the selection circuit 1206.

To the selection circuit 1206, the signal read from the antenna switch 1102 or the band select switch 1103 or a signal of information read from the register unit 1016 by the data transmitting/receiving unit 1201 and stored in the amplification control device 1101 is inputted. The selection circuit 1206 refers to the information stored in the mode control unit 1204 to determine whether the amplification control device 1101 is in write mode or read mode. When the amplification control device 1101 is in read mode, the selection circuit 1206 determines whether the read information is information from the antenna switch 1102 or the band select switch 1103 or information stored in the amplification control device 1101 of its own. In accordance with the determination result, the selection circuit 1206 transmits the information from the antenna switch 1102 or the band select switch 1103 or the information stored in the amplification control device 1101 to the input/output buffer unit 1202.

The operation of the amplification control device 1101 in write mode is described. The operation of the amplification control device 1101 in write mode is similar to the operation of the amplification control device 101 in the first embodiment. The data transmitting/receiving unit 1201 transmits the address signal and the write data signal included in the main signal to the data signal generating unit 1013 and, by the command start determining unit 1012, it is determined whether transmission of a command signal has started. The data signal generating unit 1013 generates a data signal based on command identification information, bit position information, an address signal, and write data signal from the data receiving unit 1011, and the data signal generating unit 1013 transmits the data signal to the data transmitting unit 1015. The clock enable signal generating unit 1014 generates a clock enable signal based on the command identification information and the bit position information, and transmits the clock enable signal to the data transmitting unit 1015. When receiving an input of a command detection signal and supplied with the clock enable signal from the clock enable signal generating unit 1014, the data transmitting unit 1015 transmits the data signal from the data signal generating unit 1013 to the antenna switch 1102 or the band select switch 1103, together with a clock signal supplied to the data transmitting unit 1015. As with the communication module 10 in the first embodiment, the communication module 110 performs parallel operation of communicating with a signal in the communication module 110 concurrently with reception of the main signal. Concurrently with process of interpreting the main signal from the main device 201, the amplification control device 101 performs generation of the data signal to be transmitted to the antenna switch 102 and the band select switch 103 and transmission of the data signal to the antenna switch 102 or the band select switch 103.

The operation of the amplification control device 1101 in read mode is described. Here, it is assumed that, prior to reading by the amplification control device 1101, in addition to the amplification control device 1101, the antenna switch 1102 and the band select switch 1103 are also set in read mode in advance.

The data transmitting/receiving unit 1201 receives the main signal including an address signal and a read command signal for instruction of reading of data from the antenna switch 1102 or the band select switch 1103 from the main device 201.

The data transmitting/receiving unit 1201 transmits the address signal included in the main signal to the data signal generating unit 1013. Also, the data receiving unit 1011 generates command identification information indicating reading from the antenna switch 1102 or the band select switch 1103 and bit position information indicating the position where the command identification information is to be added, and transmits these pieces of information to the data signal generating unit 1013 and the clock enable signal generating unit 1014. Note that the bit position information can include, in addition to the information where the command identification information is to be added, the position of the start and end of a signal in a data signal, such as the start position of the address signal and the start position of the read signal.

Based on the command identification information, the bit position information, and the address signal from the data receiving unit 1011, the data signal generating unit 1013 generates a read instruction signal to be transmitted to the antenna switch 102 and the band select switch 103. The data signal generating unit 1013 transmits the read instruction signal to the data transmitting unit 1015.

When receiving an input of the command detection signal and supplied with the clock enable signal from the clock enable signal generating unit 1014, the data transmitting unit 1015 transmits the read instruction signal from the data signal generating unit 1013 together with the clock signal supplied to the data transmitting unit 1015 to the antenna switch 1102 and the band select switch 1103. The data transmitting unit 1015 transmits the clock signal via the clock signal line 104 and transmits the read instruction signal via the data signal line 105. With this, an instruction for reading data from the antenna switch 1102 and the band select switch 1103 is made.

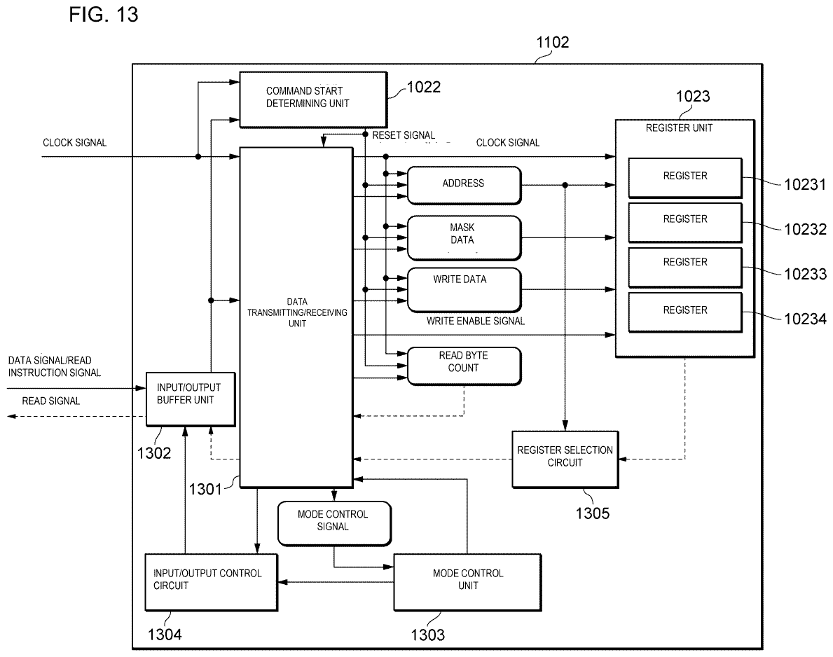

With reference to FIG. 13, the antenna switch 1102 is described. Note that other sub-devices including the band select switch 1103 also have a similar structure for the data communication. The antenna switch 1102 has, in addition to the command start determining unit 1022 and the register unit 1023 described in the first embodiment, a data transmitting/receiving unit 1301, an input/output buffer unit 1302, a mode control unit 1303, an input/output control circuit 1304, and a register selection circuit 1305.

In write mode, the data transmitting/receiving unit 1301 receives an address signal and a write data signal included in a data signal from the amplification control device 1101. In read mode, the data transmitting/receiving unit 1301 receives a read instruction signal from the amplification control device 1101.

The input/output buffer unit 1302 is a circuit that lets a signal in communication between the amplification control device 1101 and the antenna switch 1102 pass therethrough.

The mode control unit 1303 is a circuit that controls the write mode or the read mode of the antenna switch 1102. The main device 201 transmits a signal for controlling the write mode or read mode of the antenna switch 1102 via the amplification control device 1101 to the antenna switch 1102. Based on an input from the main device 201 via the amplification control device 1101, the data transmitting/receiving unit 1301 transmits a mode control signal for setting the write mode or the read mode of the antenna switch 1102 to the mode control unit 1303.

The mode control unit 1303 has information in accordance with the mode control signal stored therein. The information stored in the mode control unit 1303 is referred to by the input/output control circuit 1304.

The input/output control circuit 1304 refers to the information stored in the mode control unit 1303 to determine whether the amplification control device 1101 is in write mode or read mode. The input/output control circuit 1304 transmits a signal for controlling signal transmission and reception by the input/output buffer unit 1302 to the input/output buffer unit 1302 in accordance with the setting of the write mode and the read mode.

In write mode, the input/output control circuit 1304 controls the input/output buffer unit 1302 so that the input/output buffer unit 1302 transmits a write data signal included in the data signal to the data transmitting/receiving unit 1301.

On the other hand, in read mode, the input/output control circuit 1304 controls the input/output buffer unit 1302 so that the input/output buffer unit 1302 transmits a read signal from the antenna switch 1102 to the amplification control device 101.

The register selection circuit 1305 selects a register of the register unit 1023 based on the address of each register of the register unit 1023 of the antenna switch 1102 included in the read instruction signal. The information read from the selected register is transmitted via the data transmitting/receiving unit 1301 to the amplification control device 1101 as a read signal.

The operation of the antenna switch 1102 in write mode is described. The operation of the antenna switch 1102 in write mode is similar to the operation of the antenna switch 102 in the first embodiment. The data transmitting/receiving unit 1301 receives a data signal from the amplification control device 1101. The command start determining unit 1022 determines, based on a clock signal and the data signal, whether transmission of the data signal from the amplification control device 1101 to the antenna switch 1102 has started. Upon the start of supply of the data signal, the command start determining unit 1022 transmits a reset signal to the data transmitting/receiving unit 1301. The register unit 1023 controls writing to each register based on a signal from the data transmitting/receiving unit 1301.

The operation of the antenna switch 1102 in read mode is described. Here, it is assumed that the antenna switch 1102 is set in read mode in advance. Note that since the read mode is a mode for confirming whether the data stored in the antenna switch 1102 in write mode has been correctly written, the read mode can also be referred to as test mode. The test mode is exclusively set to each of the antenna switch 1102 and the band select switch 1103. That is, when the antenna switch 1102 is in read mode, the band select switch 1103 is not set in read mode. The data transmitting/receiving unit 1301 receives a read instruction signal from the amplification control device 1101. The data transmitting/receiving unit 1301 reads information stored in the antenna switch 1102 based on the address included in the read instruction signal. Specifically, the antenna switch 1102 determines whether the register corresponding to the address indicated by the address signal is included in the antenna switch 1102 and, when the register is included in the antenna switch 1102 and the read instruction signal is supplied from the amplification control device 1101, reads from the register the information stored in the register.

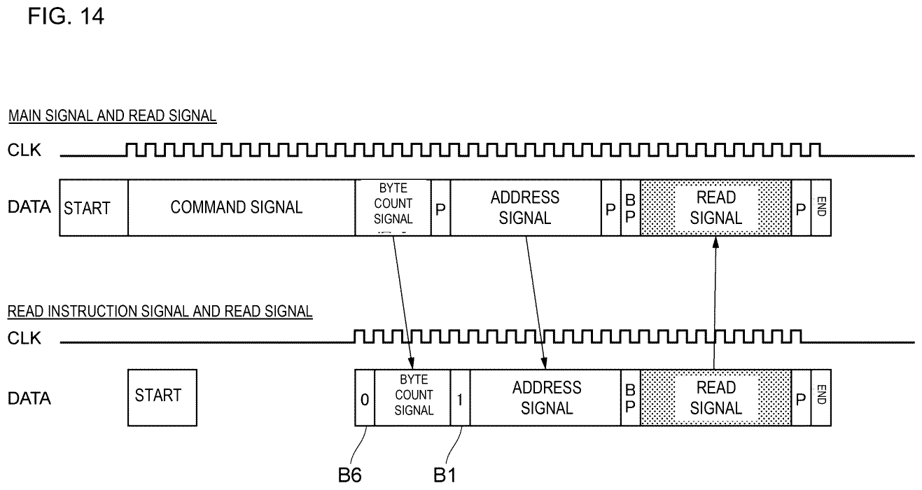

With reference to FIG. 14, signals in each of the amplification control device 1101 and the antenna switch 1102 in read mode are described. In FIG. 14, an example of signals by a command for reading from one register of the antenna switch 1102 is depicted.

A main signal received by the amplification control device 1101 includes a start signal, a command signal, a byte count signal, and an address signal. Subsequently to the main signal, a read signal is outputted from the amplification control device 1101 to the main device 201, and reading is completed with an end signal. Here, the byte count signal is a signal indicating the number of bytes of read data. The byte count signal is information of 4 bits, and a signal for setting the number of bytes from 1 byte to 16 bytes. In the example of FIG. 14, it is assumed that the byte count signal indicates reading of data having a length of 1 byte.

When the data transmitting/receiving unit 1201 receives the main signal from the main device 201, the data transmitting/receiving unit 1201 interprets the command signal. When the command signal is a command indicating reading from at least one register of the antenna switch 1102, the data signal generating unit 1013 generates information with identification information B6 added to the head of the byte count signal based on the address signal, command identification information, and bit position information.

The identification information B6 is information of 1 bit, and indicates that an instruction for data reading is made when the bit value is 0. The data transmitting unit 1015 records the identification information B6 at a position corresponding to the head clock of the byte count signal in the main signal, and transmits a data signal with the byte count signal shifted by one clock. The antenna switch 1102 reads a signal when the antenna switch 1102 is set in read mode (test mode) and the identification information B6 makes an instruction for reading data.

Subsequently, the data signal generating unit 1013 generates information with identification information B1 added to the head of the address signal. The identification information B1 is information of 1 bit, and indicates that the address length is 5 bits when the bit value is 0 and the address length is 8 bits when the bit value is 1. The data transmitting unit 1015 records the identification information B1 at a position corresponding to the head clock of the address signal in the main signal, and transmits the data signal with the address signal shifted by one clock. Note that, here, in the address signal in the main signal, a parity bit P is included at each of the head and the tail, and information indicating the actual address is recorded at a bit interposed between the parity bits P.

In the example of FIG. 14, the number of bytes identified by the byte count signal is 1. Thus, from the antenna switch 1102, a read signal of 1 byte is read. The read signal is transmitted from the data transmitting/receiving unit 1301 of the antenna switch 1102 to the amplification control device 1101 and is outputted via the data transmitting/receiving unit 1201 of the amplification control device 1101 to the main device 201.

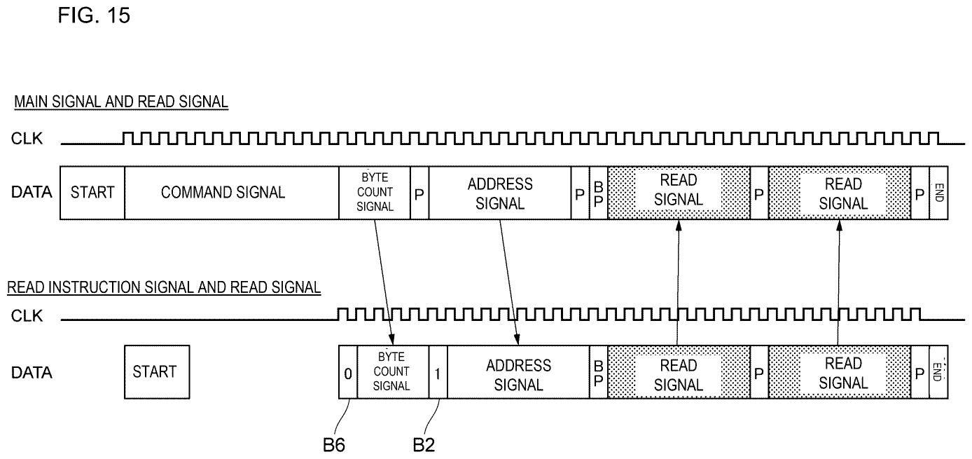

With reference to FIG. 15, another example of signals in each of the amplification control device 1101 and the antenna switch 1102 in read mode is described. In FIG. 15, an example of signals by a command for reading from two registers of the antenna switch 1102 is depicted.

A main signal received by the amplification control device 1101 includes a start signal, a command signal, a byte count signal, and an address signal. Subsequently to the main signal, a read signal is outputted from the amplification control device 1101 to the main device 201 a plurality of times, and reading is completed with an end signal. In the example of FIG. 15, it is assumed that the byte count signal indicates reading of data having a length of 2 bytes.

When the command signal is a command indicating reading from a plurality of registers of the antenna switch 1102, the data signal generating unit 1013 generates information with the identification information B6 added to the head of the byte count signal, based on the address signal, the command identification information, and the bit position information. When the antenna switch 1102 is set in read mode (test mode) and the identification information B6 makes an instruction for reading data, the antenna switch 1102 reads a signal. Subsequently, the data signal generating unit 1013 generates information with the identification information B1 added to the head of the address signal. In the example of FIG. 15, the number of bytes identified by the byte count signal is 2. Thus, from the antenna switch 1102, a read signal of 2 bytes is read.

In the communication module 110 according to the second embodiment, as with the communication module 10 described in the first embodiment, a circuit for command interpretation can be provided only to the amplification control device 1101. Since the antenna switch 1102 and the band select switch 1103 are only required to have a circuit for address interpretation, the circuit size of the antenna switch 1102 and the band select switch 1103 can be decreased. With this, the entire circuit size of the communication module 10 can be decreased.

Also in the communication module 110 according to the second embodiment, in addition to writing of information to the sub-device in the communication module 10 described in the first embodiment, it is possible to read information directly from the sub-device. Here, directly reading information means, for example, reading information itself stored in a register of the antenna switch 1102. When information is not directly read from the antenna switch 1102, the following procedure is required. First, at the time of writing information to the antenna switch 1102, a copy of the information to be written is stored in the amplification control device 1101. Next, the information stored in the amplification control device 1101 is read as information stored in the antenna switch 1102, which replaces reading of information in the antenna switch 1102. In this procedure, it is not possible to check, in practice, whether the information has been correctly written in the antenna switch 1102. For example, it can be thought that a write error occurs due to, for example, the state of a signal path between the amplification control device 1101 and the antenna switch 1102. On the other hand, in the communication module 110, since the information can be directly read from the sub-device, it is possible to appropriately check the write state at the time of product evaluation and a shipping test.

### Third Embodiment

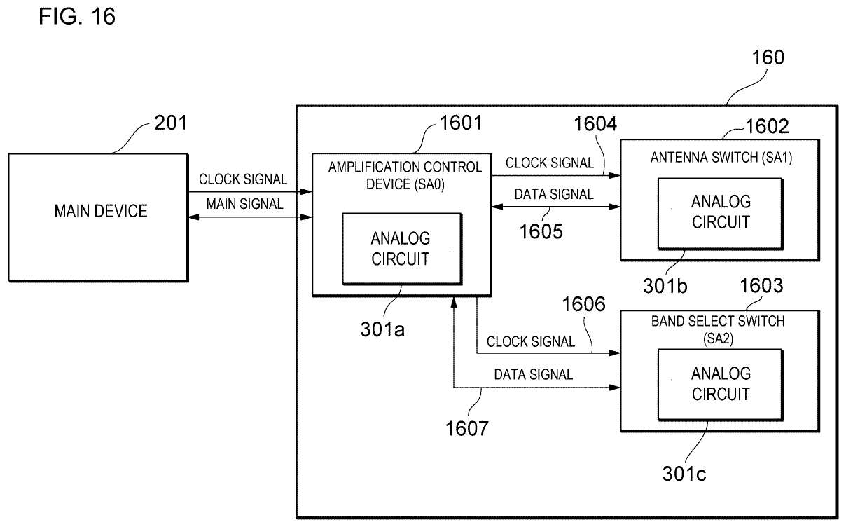

A third embodiment is described. In FIG. 16, an example of a circuit is depicted, including a communication module 160, the main device 201, and the analog circuits 301a, 301b, and 301c according to the third embodiment. The communication module 160 is a sub-device in which its data communication is controlled by the main device 201.

The communication module 160 has an amplification control device 1601, an antenna switch 1602, and a band select switch 1603.

The amplification control device 1601 is connected via a clock signal line 1604 and a data signal line 1605 to the antenna switch 1602. The amplification control device 1601 is connected via a clock signal line 1606 and a data signal line 16057 to the band select switch 1103. The communication module 160 is different from the communication module 10 according to the first embodiment in that the amplification control device 1601 is connected to each of the antenna switch 1602. 1603 via separate paths.

As with the communication module 10 described in the first embodiment and the communication module 110 described in the second embodiment, the amplification control device 1601, and the antenna switch 1602 and the band select switch 1603 perform bidirectional communications to read and write information.

In the communication module 160, to each of the amplification control device 1601, the antenna switch 1602, and the band select switch 1603, device ID information that identifies each device is allocated as a slave address. Also, in the amplification control device 1601, the device ID information of each sub-device connected to the amplification control device 1601 is stored.

In the communication module 160, a main signal including a command signal indicating operation such as writing or reading and a device ID signal indicating a device ID for identifying a device is transmitted from the main device 201 to the amplification control device 1601. Based on the device ID signal, the amplification control device 1601 performs transmission and reception of signals to the antenna switch 1602 and the band select switch 1603.

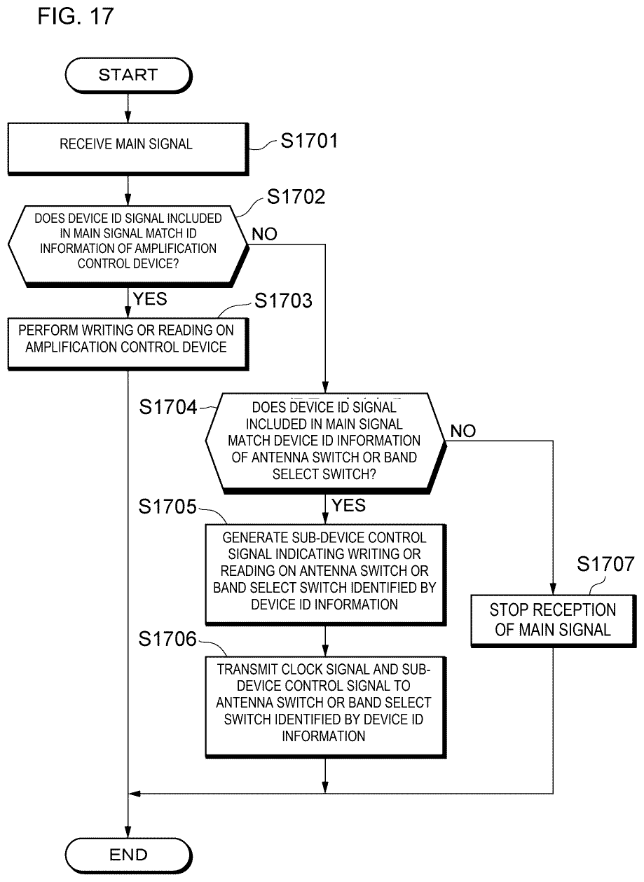

With reference to FIG. 17, the process in the amplification control device 1601 is described. At step S1701, the amplification control device 1601 receives a main signal from the main device 201.

At step S1702, the amplification control device 1601 determines whether the device ID signal included in the main signal matches the device ID information of the amplification control device 1601 itself.

When it is determined at step S1702 as positive, at step S1703, the amplification control device 1601 performs writing process or reading process on the amplification control device 1601 itself.

When it is determined at step S1702 as negative, at step S1704, the amplification control device 1601 determines whether the device ID signal included in the main signal matches the device ID information allocated to the antenna switch 1602 or the band select switch 1603.

When it is determined at step S1704 as positive, at step S1705, the amplification control device 1601 generates a sub-device control signal indicating writing or reading on the sub-device identified by the device ID information. Here, the sub-device control signal is a signal for information writing or reading described in the first embodiment and the second embodiment.

At step S1706, the amplification control device 1601 transmits a clock signal and the sub-device control signal to the sub-device identified by the device ID information.

When it is determined at step S1704 as negative, at step S1707, the amplification control device 1601 stops reception of the main signal from the main device 201.

In the communication module 160, since the amplification control device 1601 performs signal transmission and reception on the antenna switch 1602 or the band select switch 1603 based on the device identification signal, it is not required to provide a circuit that interprets the main signal in the antenna switch 1602 and the band select switch 1603. Since the antenna switch 1602 and the band select switch 1603 are only required to have a circuit for address interpretation, the circuit size of the antenna switch 1602 and the band select switch 1603 can be decreased. With this, the entire circuit size of the communication module 10 can be decreased. Also, while the amplification control device and each sub-device are identified by common addresses in the communication modules 10 and 110 in the first embodiment and the second embodiment, respectively, in the communication module 160, the amplification control device and each sub-device are identified by different addresses, allowing information writing or reading to be performed.

The embodiments have been described above. The communication module 10 according to the first embodiment includes the amplification control device 101 connected to the main device 201, and at least one second sub-device not connected to the main device 201 but connected to a first sub-device via a first signal line where a clock signal is transmitted and a second signal line where a data signal is transmitted. The amplification control device 101 receives, from the main device 201, a main signal including a command signal, an address signal that identifies an address of at least one register included in at least one second sub-device, and a write data signal to be recorded in a register corresponding to the address, the address signal being a signal subsequent to the command signal and the write data signal being a signal subsequent to the address signal; interprets the command signal; generates a write instruction signal based on an interpretation result of the command signal after reception of the command signal and during reception of the main signal when information based on the data signal is written in any of the antenna switch 102 and the band select switch 103; generates the data signal to be supplied based on the interpretation result of the command signal to each the antenna switch 102 and the band select switch 103 and based on the address signal and the write data signal after reception of the command signal and during reception of the main signal; and supplies the write instruction signal via the first signal line or the second signal line and the data signal via the second signal line to each of the antenna switch 102 and the band select switch 103 after reception of the command signal and during reception of the main signal.

In the communication module 10, the antenna switch 102 and the band select switch 103 determine whether the register corresponding to the address indicated by the address signal is included in the antenna switch 102 or the band select switch 103, and write the write data signal in the register when the register is included in the antenna switch 102 or the band select switch 103 and the write instruction signal is supplied from the amplification control device 101.

In the communication module 10, concurrently with reception of the main signal, the amplification control device 101 generates a write instruction signal when the information based on the data signal is written in either of the antenna switch 102 and the band select switch 103 based on the interpretation result of the command signal; generates a data signal to be supplied based on the interpretation result of the command signal to each of the antenna switch 102 and the band select switch 103 and based on the address signal and the write data signal; and supplies the write instruction signal via the clock signal line 104 or the data signal line 105 and the data signal via the data signal line 105 to each of the antenna switch 102 and the band select switch 103. Each of the antenna switch 102 and the band select switch 103 determines whether the register corresponding to the address indicated by the address signal is included in at least one sub-device and, when the register is included in at least one sub-device and the write instruction signal is supplied from the amplification control device 101, writes the write data signal in the register.

In the communication module 10, a circuit for command interpretation having a large circuit size can be provided only to the amplification control device 101. Since the antenna switch 102 and the band select switch 103 are only required to have a circuit for address interpretation, the circuit size of the antenna switch 102 and the band select switch 103 can be decreased. With this, the entire circuit size of the communication module 10 can be decreased. Also, concurrently with reception of the main signal, the communication module 10 generates the data signal to be transmitted to the antenna switch 102 and the band select switch 103 and transmits the data signal to the antenna switch 102 and the band select switch 103. With this, communication process is efficiently performed.

In the above-described aspect, the amplification control device 101 may generate a data signal including identification information based on a type of writing of the write data signal to at least one register, the write instruction signal may be included in a tail of the data signal as identification information, and each of the antenna switch 102 and the band select switch 103 may write the write data signal in the register based on the identification information.

With this, the antenna switch 102 and the band select switch 103 do not require a circuit for command interpretation. Thus, the circuit size of the communication module 10 can be decreased. Also, the antenna switch 102 and the band select switch 103 do not require a circuit for determining whether data writing can be performed. Thus, the circuit size of the communication module 10 can be decreased.

In the above-described aspect, the identification information may be information indicating a data length of the data signal. In the above-described aspect, the identification information may be information indicating a type of data included in the data signal.

In the above-described aspect, the type of writing may include a writing type indicating that a predetermined bit of the register is not rewritten and part of the write data signal is written in the register, the identification information may indicate that the type of data included in the data signal is the write data signal or a mask signal indicating the predetermined bit not rewritten, and each of the antenna switch 102 and the band select switch may write part of the write data signal to at least one register based on the write data signal and the mask signal. With this, it is possible to write data while masking the predetermined bit.

In the above-described aspect, the type of writing may include a writing type indicating that a first write data signal is written in a first register of the antenna switch 102 and the band select switch 103 and a second write data signal is written in a second register of at least one sub-device, the identification information may be included in a tail of each of the first write data signal and the second write data signal, and each of the antenna switch 102 and the band select switch 103 may write the first write data signal in the first register and the second write data signal in the second register based on the identification information. With this, it is possible to continuously write information in a plurality of registers. It is also possible to generate a data signal based on the main signal as keeping the data width.

In the communication module 110 according to the second embodiment, the main signal includes the command signal indicating that information is read from at least one register of the antenna switch 102 or the band select switch 103, the amplification control device 1101 generates a read instruction signal based on the address signal when information stored in at least one register is read from the antenna switch 102 or the band select switch 103 based on the interpretation result of the command signal, supplies the read instruction signal via the clock signal line 1104 or the data signal line 1105 to each of the antenna switch 102 and the band select switch 103, receives a read signal read from the register of the antenna switch 102 or the band select switch 103, and transmits the read signal to the main device 201.

In the communication module 110, the antenna switch 102 and the band select switch 103 determine whether the register corresponding to the address indicated by the address signal is included in the antenna switch 102 or the band select switch 103 and read the information stored in the register from the register when the register is included in the antenna switch 102 or the band select switch 103 and a read instruction signal is supplied from the amplification control device.

In the communication module 110, as with the communication module 10, the antenna switch 1102 and the band select switch 1103 are only required to have a circuit for address interpretation. Thus, it is possible to decrease the circuit size of the antenna switch 1102 and the band select switch 1103 and decrease the entire circuit size of the communication module 110. Furthermore, in the communication module 110, information can be directly read from the antenna switch 1102 and the band select switch 1103, and it is possible to appropriately check the write state in the antenna switch 1102 and the band select switch 1103 at the time of product evaluation and a shipping test.

In the above-described aspect, the amplification control device 1101 may generate the read instruction signal including identification information based on a type of reading from at least one register, and may receive the read signal read from the antenna switch 102 or the band select switch 103 based on the identification information. Also, in the above-described aspect, the identification information may be information indicating a data length of the read signal.

With this, for example, the read type can be set so that a signal of the same format as the format for use in a device for checking the write state is outputted, and convenience at the time of checking the write state is improved.

In the above-described aspect, the main signal may include a command signal indicating that the antenna switch 102 and the band select switch 103 is set in write mode or read mode, and the amplification control device 1101 may generate a mode setting signal for setting antenna switch 102 and the band select switch 103 in the write mode or the read mode based on the interpretation result of the command signal, may supply the mode setting signal via the clock signal line 1104 or the data signal line 1105 to the antenna switch 102 and the band select switch 103, and may receive a read signal read from the register of either the antenna switch 102 or the band select switch 103 set in read mode and supplied with the read instruction signal. With this, it is possible to set writing and reading on the sub-device.

In the above-described aspect, the write instruction signal may be a clock signal generated subsequently to the data signal. Also in the above-described aspect, the amplification control device 101, 1101 may determine not to write the write data signal in either of the antenna switch 102 and the band select switch 103 when the main signal has an error.

With this, error detection by the antenna switch 102 or the like is not required, and the circuit size of the antenna switch 102 or the like can be decreased. With this, the entire circuit size of the communication module 10, 110 can be decreased.

The communication module 160 according to the third embodiment includes: the amplification control device 1601 connected to the main device 201 to receive, from the main device 201, a main signal including a command signal and a device ID signal indicating a device ID for identifying a device, interpret the command signal, and have first device ID information allocated thereto; the antenna switch 1602 connected to the amplification control device 1601 via a first signal line where a clock signal is transmitted and a second signal line where a data signal is transmitted to have second device ID information allocated thereto; and the band select switch 1603 connected to the amplification control device 1601 via a third signal line where the clock signal is transmitted and a fourth signal line where the data signal is transmitted to have third device ID information allocated thereto.

In the communication module, the amplification control device 1601 determines whether the device ID signal included in the main signal matches the first device ID information the amplification control device 1601 has; determines whether the device ID signal included in the main signal matches the second device ID information or the third device ID information the amplification control device 1601 has; when the device ID signal included in the main signal matches the second device ID information the amplification control device 1601 has, generates a first sub-device control signal indicating data writing or reading on the antenna switch 1602 based on an interpretation result of the command signal; supplies the first sub-device control signal to the antenna switch 1602; when the device ID signal included in the main signal matches the third device ID information the amplification control device 1601 has, generates a second sub-device control signal indicating data writing or reading on the band select switch 1603 based on the interpretation result of the command signal; and supplies the second sub-device control signal to the band select switch 1603.

With this, in the antenna switch 1602 and the band select switch 1603, it is not required to provide a circuit for interpreting the main signal. Since the antenna switch 1602 and the band select switch 1603 are only required to have a circuit for address interpretation, the circuit size of the antenna switch 1602 and the band select switch 1603 can be decreased, and the entire circuit size of the communication module 10 can be decreased. Also, since the communication module 160 can identify the amplification control device and each sub-device by different addresses to write and read information, convenience of writing or reading is improved.

Note that each embodiment described above is to facilitate understanding of the present disclosure and is not to limit the present disclosure for interpretation. The present disclosure can be changed/improved without deviating from the gist of the disclosure, and also includes its equivalents. That is, those obtained by a person skilled in the art making a design change as appropriate on each embodiment are also included in the scope of the present disclosure as long as those include the features of the present disclosure. For example, the elements included in each embodiment and their arrangements, conditions, and so forth are not limited to those exemplarily described, and can be changed as appropriate. Also, each embodiment is merely an example and, needless to say, partial replacement or combination of the structures described in different embodiments can be made, and these are also included in the scope of the present disclosure as long as they include the features of the present disclosure.

<1> A communication module including: a first sub-device connected to a main device; and at least one second sub-device not connected to the main device but connected to the first sub-device via a first signal line where a clock signal is transmitted and a second signal line where a data signal is transmitted, in which the first sub-device receives, from the main device, a main signal including a command signal, an address signal that identifies an address of at least one register included in at least one second sub-device, and a write data signal to be recorded in a register corresponding to the address, the address signal being a signal subsequent to the command signal and the write data signal being a signal subsequent to the address signal, interprets the command signal, generates a write instruction signal based on an interpretation result of the command signal after reception of the command signal and during reception of the main signal when information based on the data signal is written in any of the at least one second sub-device, generates the data signal to be supplied based on the interpretation result of the command signal to each of the at least one second sub-device and based on the address signal and the write data signal after reception of the command signal and during reception of the main signal, and supplies the write instruction signal via the first signal line or the second signal line and the data signal via the second signal line to each of the at least one second sub-device after reception of the command signal and during reception of the main signal, and each of the at least one second sub-device determines whether the register corresponding to the address indicated by the address signal is included in the at least one second sub-device, and writes the write data signal in the register when the register is included in the at least one second sub-device and the write instruction signal is supplied from the first sub-device.

<2> The communication module according to <1>, in which the first sub-device generates the data signal including identification information based on a type of writing of the write data signal to the at least one register, the write instruction signal being included in a tail of the data signal as the identification information, and each of the at least one second sub-device writes the write data signal in the register based on the identification information.

<3> The communication module according to <1>, in which the identification information is information indicating a data length of the data signal.

<4> The communication module according to <2>, in which the identification information is information indicating a type of data included in the data signal.

<5> The communication module according to <4>, in which the type of writing includes a writing type indicating that a predetermined bit of the register is not rewritten and part of the write data signal is written in the register, the identification information indicates that the type of data included in the data signal is the write data signal or a mask signal indicating the predetermined bit not rewritten, and each of the at least one second sub-device writes part of the write data signal to the at least one register based on the write data signal and the mask signal.

<6> The communication module according to <4> or <5>, in which the type of writing includes a writing type indicating that a first write data signal is written in a first register of the at least one second sub-device and a second write data signal is written in a second register of the at least one second sub-device, the identification information is included in a tail of each of the first write data signal and the second write data signal, and each of the at least one second sub-device writes the first write data signal in the first register and the second write data signal in the second register based on the identification information.

<7> The communication module according to any one of <1> to <6>, in which the write instruction signal is the clock signal generated subsequently to the data signal.

<8> The communication module according to any one of <1> to <7>, in which the main signal includes the command signal indicating that information is read from the at least one register of the at least one second sub-device, the first sub-device generates a read instruction signal based on the address signal when information stored in the at least one register is read from the at least one second sub-device

based on the interpretation result of the command signal, supplies the read instruction signal via the first signal line or the second signal line to each of the at least one second sub-device, receives a read signal read from the register of any of the at least one second sub-device, and transmits the read signal to the main device.

<9> The communication module according to <8>, in which the first sub-device generates the read instruction signal including identification information based on a type of reading from the at least one register, and receives the read signal read from the at least one second sub-device based on the identification information.

<10> The communication module according to <9>, in which the identification information is information indicating a data length of the read signal.

<11> The communication module according to any one of <8> to <10>, in which the main signal includes the command signal indicating that the at least one second sub-device is set in write mode or read mode, and the first sub-device generates a mode setting signal for setting the at least one second sub-device in write mode or read mode based on the interpretation result of the command signal, supplies the mode setting signal via the first signal line or the second signal line to each of the at least one second sub-device, and receives a read signal read from the register of any of the at least one second sub-device set in read mode and supplied with the read instruction signal.

<12> The communication module according to any one of <1> to <11>, in which the first sub-device is an amplification control device that controls a power amplifier circuit, and the at least one second sub-device is an antenna switch that selects a signal amplified by the power amplifier circuit and transmitted and received via an antenna or a band select switch that selects a wavelength of a signal transmitted and received via the antenna.

<14> The communication module according to any one of <1> to <13>, in which the first sub-device determines not to write the write data signal in any of the at least one second sub-device when the main signal has an error.

<15> A communication module including: a first sub-device connected to a main device to receive, from the main device, a main signal including a command signal and a device ID signal indicating a device ID for identifying a device, interpret the command signal, and have first device ID information allocated thereto; a second sub-device connected to the first sub-device via a first signal line where a clock signal is transmitted and a second signal line where a data signal is transmitted to have second device ID information allocated thereto; and a third sub-device connected to the first sub-device via a third signal line where the clock signal is transmitted and a fourth signal line where the data signal is transmitted to have third device ID information allocated thereto, in which the first sub-device determines whether the device ID signal included in the main signal matches the first device ID information the first sub-device has, determines whether the device ID signal included in the main signal matches the second device ID information or the third device ID information the first sub-device has, when the device ID signal included in the main signal matches the second device ID information the first sub-device has, generates a first sub-device control signal indicating data writing or reading on the second sub-device based on an interpretation result of the command signal, supplies the first sub-device control signal to the second sub-device, when the device ID signal included in the main signal matches the third device ID information the first sub-device has, generates a second sub-device control signal indicating data writing or reading on the third sub-device based on the interpretation result of the command signal, and supplies the second sub-device control signal to the third sub-device.

What is claimed is:

1. A communication module comprising:
a first sub-device connected to a main device; and
at least one second sub-device not connected to the main device but connected to the first sub-device via a first signal line where a clock signal is transmitted, and via a second signal line where a data signal is transmitted,
wherein the first sub-device is configured to:
receive, from the main device, a main signal including a command signal, an address signal that identifies an address of at least one register included in at least one second sub-device, and a write data signal to be recorded in a register corresponding to the address, the address signal being a signal subsequent to the command signal and the write data signal being a signal subsequent to the address signal,
interpret the command signal,
generate a write instruction signal based on an interpretation result of the command signal after reception of the command signal and during reception of the main signal when information based on the data signal is written in any of the at least one second sub-device,
generate the data signal based on the interpretation result of the command signal to each of the at least one second sub-device based on the address signal and the write data signal after reception of the command signal and during reception of the main signal, and
supply the write instruction signal via the first signal line or the second signal line and the data signal via the second signal line to each of the at least one second sub-device after reception of the command signal and during reception of the main signal, and
wherein each of the at least one second sub-device is configured to:
determine whether the register corresponding to the address indicated by the address signal is included in the at least one second sub-device, and
write the write data signal in the register when the register is included in the at least one second sub-device and the write instruction signal is supplied from the first sub-device.

2. The communication module according to claim 1,
wherein the first sub-device is configured to generate the data signal including identification information based on a type of writing of the write data signal to the at least one register, the write instruction signal being included in a tail of the data signal as the identification information, and
wherein each of the at least one second sub-device is configured to write the write data signal in the register based on the identification information.

3. The communication module according to claim 2, wherein the identification information is information indicating a data length of the data signal.

4. The communication module according to claim 2, wherein the identification information is information indicating a type of data included in the data signal.

5. The communication module according to claim 4,
wherein the type of writing includes a writing type indicating that a predetermined bit of the register is not rewritten and part of the write data signal is written in the register,
wherein the identification information indicates that the type of data included in the data signal is the write data signal or a mask signal indicating the predetermined bit not rewritten, and
wherein each of the at least one second sub-device is configured to write part of the write data signal to the at least one register based on the write data signal and the mask signal.

6. The communication module according to claim 4,
wherein the type of writing includes a writing type indicating that a first write data signal is written in a first register of the at least one second sub-device and a second write data signal is written in a second register of the at least one second sub-device,
wherein the identification information is included in a tail of each of the first write data signal and the second write data signal, and
wherein each of the at least one second sub-device is configured to write the first write data signal in the first register and the second write data signal in the second register based on the identification information.

7. The communication module according to claim 1, wherein the write instruction signal is the clock signal generated subsequently to the data signal.

8. The communication module according to claim 1,
wherein the main signal includes the command signal indicating that information is read from the at least one register of the at least one second sub-device, and
wherein the first sub-device is configured to:
generate a read instruction signal based on the address signal when information stored in the at least one register is read from the at least one second sub-device based on the interpretation result of the command signal,
supply the read instruction signal via the first signal line or via the second signal line to each of the at least one second sub-device,
receive a read signal read from the register of any of the at least one second sub-device, and
transmit the read signal to the main device.

9. The communication module according to claim 8, wherein the first sub-device is configured to:
generate the read instruction signal including identification information based on a type of reading from the at least one register, and
receive the read signal read from the at least one second sub-device based on the identification information.

10. The communication module according to claim 9, wherein the identification information is information indicating a data length of the read signal.

11. The communication module according to claim 8,
wherein the main signal includes the command signal indicating that the at least one second sub-device is set in write mode or read mode, and
wherein the first sub-device is configured to:
generate a mode setting signal for setting the at least one second sub-device in write mode or read mode based on the interpretation result of the command signal,
supply the mode setting signal via the first signal line or the second signal line to each of the at least one second sub-device, and
receive a read signal read from the register of any of the at least one second sub-device set in read mode and supplied with the read instruction signal.

12. The communication module according to claim 1,
wherein the first sub-device is an amplification control device configured to control a power amplifier circuit, and
wherein the at least one second sub-device is an antenna switch configured to select a signal amplified by the power amplifier circuit and transmitted and received via an antenna, or a band select switch configured to select a wavelength of a signal transmitted and received via the antenna.

13. The communication module according to claim 1, wherein the first sub-device is configured to not write the write data signal in any of the at least one second sub-device when the main signal has an error.

14. A communication module comprising:
a first sub-device connected to a main device and configured to receive, from the main device, a main signal including a command signal and a device ID signal indicating a device ID for identifying a device, interpret the command signal, and have first device ID information allocated thereto;
a second sub-device connected to the first sub-device via a first signal line where a clock signal is transmitted and via a second signal line where a data signal is transmitted to have second device ID information allocated thereto; and
a third sub-device connected to the first sub-device via a third signal line where the clock signal is transmitted and via a fourth signal line where the data signal is transmitted to have third device ID information allocated thereto,
wherein the first sub-device is configured to:
determine whether the device ID signal included in the main signal matches the first device ID information the first sub-device has,
determine whether the device ID signal included in the main signal matches the second device ID information or the third device ID information the first sub-device has,
when the device ID signal included in the main signal matches the second device ID information the first sub-device has, generate a first sub-device control signal indicating data writing or reading on the second sub-device based on an interpretation result of the command signal,
supply the first sub-device control signal to the second sub-device,
when the device ID signal included in the main signal matches the third device ID information the first sub-device has, generate a second sub-device control signal indicating data writing or reading on the third sub-device based on the interpretation result of the command signal, and
supply the second sub-device control signal to the third sub-device.
